(19) United States
(12) Patent Application Publication
(10) Pub. No.: US 2011/0061484 A1
(43) Pub. Date: Mar. 17, 2011

(54) DEVICE FOR URGING RELATIVE MOVEMENT AND ELECTRONIC APPARATUS EMPLOYING DEVICE FOR URGING RELATIVE MOVEMENT

(75) Inventors: Ryo Shimomura, Toshima-ku (JP); Tsuyoshi Kano, Toshima-ku (JP)

(73) Assignee: Kabushiki Kaisha Strawberry Corporation, Tokyo (JP)

(21) Appl. No.: 12/561,012

(22) Filed: Sep. 16, 2009

(51) Int. Cl. F16H 21/54

(52) U.S. Cl. 74/100.1

(57) ABSTRACT

It is an object of the present invention to provide an innovative device for urging relative movement and an electronic apparatus in the device for urging relative movement is employed, the device and apparatus having extremely high commercial value. The present invention is a device for urging relative movement of a first member (1) and a second member (2) that are linked so as to allow relative movement, the device for urging relative movement comprising a first linking unit (3) for linking to the first member (1); and a second linking unit (4) for linking to the second member (2), the second linking unit being connected to the first linking unit (3) so as to be able to slide in an outward-sliding direction in response to urging, wherein one end part of an urging unit (8) is connected to an urging unit connecting part (10) that is provided to the first linking unit (3), and the other end part of the urging unit is connected to an urging unit connecting part (6) that is provided to the second linking unit (4); and a part (12) for concealing and supporting the urging unit is provided to one or both of the first linking unit (3) and the second linking unit (4), the part for concealing and supporting the urging unit being positioned outwardly with respect to the urging unit (8) and being capable of supporting the urging unit (8) in a concealed state.

### BACKGROUND OF THE INVENTION

1. Field of the Invention

The present invention relates to a device for urging relative movement and to a cellular telephone, portable electronic device, or other electronic apparatus in which the device for urging relative movement is employed.

2. Description of the Related Art

In, e.g., a conventional folding cellular telephone, an operation part upon which number keys and function keys are arranged is provided to an upper surface side of a lower main body. A liquid crystal panel or other display part upon which a predetermined display is produced according to, e.g., the operation of the keys of the operation part is provided to the downward-facing surface side (overlaying side) of an upper overlay part. The main body part and the overlay part are linked by a hinge device. The configuration is such that a switch can be made from a closed state, in which the main body part and the overlay part are folded and overlaid, and the operation part is concealed by the overlay part, to an open state in which the overlay part is flipped open using the hinge device, so that the operation part and the display part are exposed.

In a conventional electronic apparatus in which the operation part of the main body part is covered by the overlay part that flips, the structure is such that, although the apparatus may be folded over into a compact state, the display part is also concealed in the overlaid state in which the operation part is concealed. As a result, use in the compact state may often be restricted and Inconvenient.

When the operating part is operated, the heavy overlay part to which the display part is provided must be flipped open. A drawback is presented in that the opening and closing movements (in particular, the opening movement) are difficult to perform.

Accordingly, the display part can be provided to the upper surface of the overlay part if a configuration is adopted wherein opening and closing are not performed with a flipping movement but by sliding the overlay part in a longitudinal direction along the overlay surface. The display part is disposed above, and can be viewed or made to function, even when overlaid while, e.g., the apparatus is not being used or the keys need not be operated; i.e., even when in the compact state in which, e.g., the overlay part provided with the display part is overlaid on the main body part and the operating part is concealed. The switch from the overlaid, compact state to the state in which the operating part is exposed can be performed by sliding the overlay part in the longitudinal direction along the overlay surface. The result is a cellular telephone, portable electronic device, or other electronic apparatus allowing the releasing operation to be very readily performed, the scope of application for the apparatus to be increased, and opening and closing to be readily performed.

When such a sliding configuration for opening and closing is used, a sliding device for slidably linking the main body part and the overlay part is used, but the configuration is preferably one wherein the overlay part automatically slides to a open position in which the operating part is exposed when sliding from the overlaid and closed position, in which the operating part of the main body part is concealed by the overlay part, to a predetermined slide position in which the overlay part has slid forward.

Accordingly, the present applicants have provided devices for urging relative movement disclosed in, e.g., Japanese Patent Application 2007-317580 and Japanese Patent Application 2008-41570 (referred to below as conventional art examples). In these devices, an urging force is provided to a sliding structural part (relative-movement structural part) for causing the overlay part to slide relative to the main body part along the overlay surface.

These conventional art examples have a first linking unit for linking to the main body part and a second linking unit that is connected to the first linking unit so as to be able to slide in response to urging in an outward direction and that links to the overlay part. The conventional art examples exhibit an urging effect for urging the sliding of the overlay part relative to the main body part such that return urging for causing the overlay part to slide back in a return direction is generated until the overlay part is made to slide a predetermined distance relative to the main body part. Once the overlay part has been made to slide the predetermined distance, propelling urging for causing the overlay part to slide forward in the opposite direction is generated.

The structures of these conventional art examples allow the device for urging relative movement itself to be made compact, and, additionally, the component for urging relative movement provided with the device to be made reliably compact.

### SUMMARY OF THE INVENTION

The present inventors have continued the development of the aforedescribed devices for urging relative movement provided to a relative-movement structural part. As a result of repeated experiments and research, the present inventors have developed an innovative device for urging relative movement, and an electronic apparatus employing the device for urging relative movement, both of which exhibiting operational effects nonexistent in the conventional art.

The main points of the present invention will be described with reference to the accompanying drawings.

According to a first aspect, there is provided a device for urging relative movement of a first member 1 and a second member 2 that are linked so as to allow relative movement, the device for urging relative movement comprising a first linking unit 3 for linking to the first member 1; and a second linking unit 4 for linking to the second member 2, the second linking unit being connected to the first linking unit 3 so as to be able to slide in an outward-sliding direction in response to urging, wherein one end part of an urging unit 8 is connected to an urging unit connecting part 10 that is provided to the first linking unit 3, and the other end part of the urging unit is connected to an urging unit connecting part 6 that is provided to the second linking unit 4; a part 12 for concealing and supporting the urging unit is provided to one or both of the first linking unit 3 and the second linking unit 4, the part for concealing and supporting the urging unit being positioned outwardly with respect to the urging unit 8 and being capable of supporting the urging unit 8 in a concealed state; and the part 12 for concealing and supporting the urging unit is configured so as to prevent the urging unit 8 from outwardly deforming while the urging unit 8 urges the first linking unit 3 and the second linking unit 4 in the outward-sliding direction.

According to a second aspect, there is provided a device for urging relative movement according to the first aspect, wherein first end parts of a plurality of respective urging units 8 arranged in parallel are connected to the urging unit connecting part 10 that is provided to the first linking unit 3, and second end parts of the urging units are connected to the urging unit connecting part 6 that is provided to the second linking unit 4; and the part 12 for concealing and supporting the urging unit is provided to one or both of the first linking unit 3 and the second linking unit 4, the part for concealing and supporting the urging unit being positioned outwardly with respect to the urging units 8 and being capable of supporting the urging units 8 in a concealed state.

According to a third aspect, there is provide a device for urging relative movement according to the second aspect, further comprising a contact-preventing unit 20 for preventing contact between the urging units 8, the contact-preventing unit being positioned between the urging units 8 and being provided to the part 12 for concealing and supporting the urging unit.

According to a fourth aspect, there is provided a device for urging relative movement according to the first aspect, further comprising a thin plate unit positioned outwardly with respect to the urging unit 8 on an upper side or a lower side of the urging unit, or both upper and lower sides thereof 8, wherein the part 12 for concealing and supporting the urging unit that is capable of supporting the urging unit 8 in a concealed state is provided to one or both of the first linking unit 3 and the second linking unit 4.

According to a fifth aspect, there is provided a device for urging relative movement of a first member 1 and a second member 2 that are linked so as to allow relative movement, the device for urging relative movement comprising a first linking unit 3 for linking to the first member 1; and a second linking unit 4 for linking to the second member 2, the second linking unit being connected to the first linking unit 3 so as to be able to slide in an outward-sliding direction in response to urging, wherein one end part of an urging unit 8 is connected to an urging unit connecting part 10 that is provided to the first linking unit 3, and the other end part of the urging unit is connected to an urging unit connecting part 6 that is provided to the second linking unit 4; a part 12 for concealing and supporting the urging unit is provided to one or both of the first linking unit 3 and the second linking unit 4, the part for concealing and supporting the urging unit being positioned outwardly with respect to the urging unit 8 and being capable of supporting the urging unit 8 in a concealed state; a slidably linking sliding part 14 is provided to the part 12 for concealing and supporting the urging unit, one or both of the urging unit connecting part 6 of the second linking unit 4 and the urging unit connecting part 10 of the first linking unit 3 acting as guides; and the first linking unit 3 and the second linking unit 4 are slidably linked.

According to a sixth aspect, there is provided a device for urging relative movement according to the fifth aspect, wherein a sliding component between the sliding part 14, which is provided to the part 12 for concealing and supporting the urging unit, and one or both of the urging unit connecting part 6 of the second linking unit 4 and the urging unit connecting part 10 of the first linking unit 3 is a member made of a synthetic resin, the sliding part 14 sliding along the urging unit connecting parts.

According to a seventh aspect, there is provided a device for urging relative movement according to the fifth of or sixth aspect, wherein a plurality of the urging units 8 are arranged in parallel on the urging unit connecting parts 6, 10; and a contact-preventing unit 20 for preventing contact between the urging units 8 is positioned between the urging units 8 and is provided to the part 12 for concealing and supporting the urging unit.

According to an eighth aspect, there is provided a device for urging relative movement according to the fifth aspect, further comprising a thin plate unit positioned outwardly with respect to the urging unit 8 on an upper side or a lower side of the urging unit 8, or both upper and lower sides thereof, the thin plate unit being provided to the part 12 for concealing and supporting the urging unit.

According to a ninth aspect, there is provided a device for urging relative movement according to the fifth aspect, further comprising a retaining lock part 18 for interlocking with a lock part 16, which is provided to one or both of the second linking unit 4 and the first linking unit 3, at a predetermined location where the sliding part 14 has slid against a return urging of the urging unit 8, the retaining lock part being provided to one or both of the first linking unit 3 and the second linking unit 4.

According to a tenth aspect, there is provided a device for urging relative movement of a first member 1 and a second member 2 that are linked so as to allow relative movement, the device for urging relative movement comprising a first linking unit 3 for linking to the first member 1; a second linking unit 4 for linking to the second member 2; and a linking unit 5 for linking to the first linking unit 3 and the second linking unit 4 so as to allow sliding together in an outward direction in response to urging, wherein one end part of a first urging unit 8A is connected to an urging unit connecting part 6 that is provided to the linking unit 5, and the other end part of the first urging unit is connected to an urging unit connecting part 10 that is provided to the first linking unit 3; one end part of a second urging unit 8B is connected to an urging unit connecting part 7 that is provided to the linking unit 5, and the other end part of the second urging unit is connected to an urging unit connecting part 11 that is provided to the second linking unit 4; a first part 12 for concealing and supporting the urging unit is provided to one or both of the first linking unit 3 and the linking unit 5, the first part for concealing and supporting the urging unit being positioned outwardly with respect to the first urging unit 8A and being capable of supporting the first urging unit 8A in a concealed state; a second part 13 for concealing and supporting the urging unit is provided to one or both of the second linking unit 4 and the linking unit 5, the second part for concealing and supporting the urging unit being positioned outwardly with respect to the second urging unit BB and being capable of supporting the second urging unit BB in a concealed state; the first part 12 for concealing and supporting the urging unit is configured so as to prevent the first urging unit 8A from outwardly deforming while the first urging unit 8A urges the first linking unit 3 and the linking unit 5 in the outward direction; and the second part 13 for concealing and supporting the urging unit is configured so as to prevent the second urging unit 8B from outwardly deforming while the second urging unit 8B urges the second linking unit 4 and the linking unit 5 in the outward direction.

According to an eleventh aspect, there is provided a device for urging relative movement of a first member 1 and a second member 2 that are linked so as to allow relative movement, the device for urging relative movement comprising a first linking unit 3 for linking to the first member 1; a second linking unit 4 for linking to the second member 2; and a linking unit 5 for linking to the first linking unit 3 and the second linking unit 4 so as to allow sliding together in an outward direction in response to urging, wherein one end part of a first urging unit 8A is connected to an urging unit connecting part 6 that is provided to the linking unit 5, and the other, end part of the first urging unit is connected to an urging unit connecting part 10 that is provided to the first linking unit 3; one end part of a second urging unit 8B is connected to an urging unit connecting part 7 that is provided to the linking unit 5, and the other end part of the second urging unit is connected to an urging unit connecting part 11 that is provided to the second linking unit 4; a first part 12 for concealing and supporting the urging unit is provided to one or both of the first linking unit 3 and the linking unit 5, the first part for concealing and supporting the urging unit being positioned outwardly with respect to the first urging unit 8A and being capable of supporting the first urging unit 8A in a concealed state; a second part 13 for concealing and supporting the urging unit is provided to one or both of the second linking unit 4 and the linking unit 5, the second part for concealing and supporting the urging unit being positioned outwardly with respect to the second urging unit 8B and being capable of supporting the second urging unit 8B in a concealed state; a slidably linking sliding part 14 is provided to the first part 12 for concealing and supporting the urging unit, one or both of the urging unit connecting part 6 of the linking unit 5 and the urging unit connecting part 10 of the first linking unit 3 acting as guides; a slidably linking sliding part 15 is provided to the second part 13 for concealing and supporting the urging unit, one or both of the urging unit connecting part 7 of the linking unit 5 and the urging unit connecting part 11 of the second linking unit 4 acting as guides; and the first linking unit 3 and the second linking unit 4 are slidably linked to the linking unit 5.

According to a twelfth aspect, there is provided an electronic apparatus, comprising the device for urging relative movement according to any of the first through eleventh aspects, the device for urging relative movement being provided to a relative-movement structural part for linking the first member 1, upon which an operating part or the like is disposed, and the second member 2, upon which a display part or the like is disposed, so as to allow relative movement.

According to the aforedescribed constitutions, the invention makes it possible to obtain an extremely high-quality device for urging relative movement in which, e.g., no noise is produced during operation, and the durability of the urging unit is dramatically improved. The number of components is significantly reduced, whereby the structure is made as simple as possible, and the device for urging relative movement itself can be reduced in weight and made more compact in a simple and reliable manner. An, e.g., electronic apparatus provided with the device for urging relative movement can therefore also be reduced in weight and made more compact. The present invention is an innovative device for urging relative movement offering extremely high commercial value and exhibiting, e.g., exceptional urging operation.

The more specific constitutions of the inventions according to the second through fourth aspects make it possible to reliably achieve the desired objects and otherwise yield an innovative device for urging relative movement exhibiting operational effects nonexistent in the conventional art.

The invention according to the fifth aspect supplements the operational effects of the invention according to the first aspect. A further degree of compactness is reliably achieved, and the durability of the urging unit is dramatically improved. The invention according to the fifth aspect is an innovative device for urging relative movement that is exceptional in regard to mass productivity while also exhibiting other operational effects nonexistent in the conventional art.

The more specific constitutions of the inventions according to the sixth through ninth aspects make it possible to reliably achieve the desired objects and otherwise, yielding an innovative device for urging relative movement exhibiting operational effects nonexistent in the conventional art.

The inventions according to the tenth and eleventh aspects supplement the operational effects of the invention according to the first and fifth aspects. A further degree of compactness is reliably achieved, and the durability of the urging unit is dramatically improved. The inventions according to the tenth and eleventh aspects are innovative devices for urging relative movement that are exceptional in regard to mass productivity while also exhibiting other operational effects nonexistent in the conventional art.

The invention according to the twelfth aspect makes it possible to provide an electronic apparatus having the innovative device for urging relative movement, whereby an exceptional degree of practical utility is achieved, and the operational effects described above are exhibited.

### BRIEF DESCRIPTION OF THE DRAWINGS

FIG. 1 is a descriptive diagram of the present example in a state of usage;

FIG. 2 is a perspective view showing the present example;

FIG. 3 is a descriptive diagram of the operation of the present example;

FIG. 4 is an exploded view showing the present example;

FIG. 5 is a descriptive diagram of the operation of the present example;

FIG. 6 is a descriptive cross-sectional view of the present example;

FIG. 7 is a perspective view of the main part according to the present example;

FIG. 8 is a cross-sectional view of the main part according to the present example;

FIG. 9 is an end view of the main part according to the present example;

FIG. 10 is a descriptive cross-sectional view of the main part according to the present example;

FIG. 11 is a descriptive cross-sectional view of the main part according to another example;

FIG. 12 is a plan view of the main part according to the present example;

FIG. 13 is an end view of the main part according to the present example;

FIG. 14 is a descriptive perspective view of the main part according to the present example;

FIG. 15 is a descriptive perspective view of the main part according to another example;

FIG. 16 is a schematic descriptive diagram of the operation of the present example;

FIG. 17 is a schematic descriptive diagram of the operation of the present example; and

FIG. 18 is a schematic descriptive diagram of the operation of the present example.

### DESCRIPTION OF THE PREFERRED EMBODIMENTS

Preferred embodiments of the present invention will be straightforwardly described below with reference to the accompanying drawings.

The present invention is provided to a linking component (relative-movement structural part) between a first member 1 and a second member 2 to form a link capable of relative movement, whereby an urging force can be imparted to the relative movement of the first member 1 and the second member 2.

Specifically, the present invention has a configuration in which a first linking unit 3 and a second linking unit 4 are brought together, whereby relative-movement urging for urging in the outward-sliding direction is generated. When the present invention is provided to, e.g., a sliding structural part (relative-movement structural part) for causing the overlaid second member 2 to slide relative to the first member 1 along the overlay surface, an urging effect is exhibited such that when the first linking unit 3 is linked to the first member 1 and the second linking unit 4 is linked to the second member 2, return urging for causing the second member 2 to slide back in the returning direction is generated until the second member 2 is made to slide a predetermined distance relative to the first member 1. Once the second member has slid the predetermined distance, propelling urging for causing the second member 2 to slide forward relative to the first member 1 in an opposite, forward direction is generated.

The present invention has the first linking unit 3 for linking to the first member 1, and the second linking unit 4 that is connected to the first linking unit 3 so as to be able to slide in the outward direction in response to urging and that is linked to the second member 2. One end part of an urging unit 8 is connected to an urging unit connecting part 10 that is provided to the first linking unit 3. The other end part of the urging unit 8 is connected to an urging unit connecting part 6 that is provided to the second linking unit 4. A part 12 for concealing and supporting the urging unit is provided to one or both of the first linking unit 3 and the second linking unit 4. The part for concealing and supporting the urging unit is positioned outwardly with respect to the urging unit 8 and is capable of supporting the urging unit 8 in a concealed state. The part 12 for concealing and supporting the urging unit is configured so as to prevent the urging unit 8 from outwardly deforming while the urging unit 8 urges the first linking unit 3 and the second linking unit 4 in the outward-sliding direction. This configuration results in a high-quality device for urging relative movement.

In other words, the configuration described above allows the first linking unit 3 and the second linking unit 4 employed in the conventional art examples to slide, and obviates the use of a shaft for supporting the urging unit (coil spring). Therefore, the noise conventionally generated when the urging unit rubs against the shaft during operation is not produced, the durability of the urging unit 8 can be improved, and smooth sliding in the sliding structure is achieved. As mentioned above, the shaft is unnecessary, and the urging unit 8 can be assembled via the assembling of the main body of the device (e.g., the first linking unit 3 and the second linking unit 4), resulting in extremely simple assembly and lower costs.

In the present invention, the part 12 for concealing and supporting the urging unit makes it possible to prevent foreign matter from adhering to the urging unit 8 or the urging unit 8 from contacting external structural elements (e.g., plate metal constituting sliding devices and flexible wires). The structure is also waterproof, which additionally improves the durability of the urging unit 8. The grease conventionally applied to the periphery of the urging unit 8 is obviated or largely unnecessary; therefore, assembly can be performed very readily, and costs are reduced.

As in the invention according to the fifth aspect, a slidably linking sliding part 14 is provided to the part 12 for concealing and supporting the urging unit, one or both of the urging unit connecting part 6 of the second linking unit 4 and the urging unit connecting part 10 of the first linking unit 3 acting as guides. When the first linking unit 3 and the second linking unit 4 are slidably linked, one or both of the urging unit connecting part 6 of the second linking unit 4 and the urging unit connecting part 10 of the first linking unit 3 functions as a guide for the sliding part 14; therefore, the dual functionality of the parts allows only the minimally required parts to be used, weight to be reduced, and a degree of compactness to be reliably attained.

Smooth sliding is achieved in cases wherein, e.g., the sliding component between the sliding part 14, which is provided to the part 12 for concealing and supporting the urging unit, and one or both of the urging unit connecting part 10 of the first linking unit 3 and the urging unit connecting part 6 of the second linking unit 4, is a member made of synthetic resin, the sliding part 14 sliding along the urging unit connecting parts. Moreover, no noise is produced during operation (while sliding).

Contact between the urging units 8 is reliably prevented in cases wherein, e.g., a plurality of the urging units 8 are arranged in parallel on the urging unit connecting parts 6, 10, and a contact-preventing unit 20 that is positioned between the urging units 8 for preventing contact between the urging units 8 is provided to the part 12 for concealing and supporting the urging unit. Durability of the urging units 8 can also be dramatically improved in this respect.

In cases in which, e.g., the part 12 for concealing and supporting the urging unit is shaped as a flat, thin case, the device for urging relative movement and the, e.g., electronic apparatus provided with the device for urging relative movement, will be further reduced in weight and made more compact.

In cases in which, e.g., one or both of the first linking unit 3 and the second linking unit 4 is provided with a retaining lock part 18 for interlocking with a lock part 16, which is provided to one or both of the second linking unit 4 and the first linking unit 3, at a predetermined location where the sliding part 14 has slid against the return urging of the urging unit 8, the assembly of the main body of the device will be completed merely by the retaining lock part 18 interlocking with the lock part 16. Therefore, assembly can be very readily performed, mass productivity will be dramatically improved, and costs will be reduced.

Further operational effects are exhibited in addition to the effects of the aforedescribed first and fifth aspects in cases in which, as in the inventions according to tenth and eleventh aspects, the first linking unit 3 for linking to the first member 1, the second linking unit 4 for linking to the second member 2, and a linking unit 5 for linking the first linking unit 3 and the second linking unit 4 so as to allow sliding together in the outward direction in response to urging are present. One end part of a first urging unit 8A is connected to the urging unit connecting part 6 provided to the linking unit 5. The other end part is connected to the urging unit connecting part 10 that is provided to the first linking unit 3. One end part of a second urging unit 8B is connected to an urging unit connecting part 7 provided to the linking unit 5. The other end part is connected to an urging unit connecting part 11 that is provided to the second linking unit 4. The first part 12 for concealing and supporting the urging unit is provided to one or both of the first linking unit 3 and the linking unit 5. The first part for concealing and supporting the urging unit is positioned outwardly with respect to the first urging unit 8A and is capable of supporting the first urging unit 8A in a concealed state. A second part 13 for concealing and supporting the urging unit is provided to one or both of the second linking unit 4 and the linking unit 5. The second part for concealing and supporting the urging unit is positioned outwardly with respect to the second urging unit 8B and is capable of supporting the second urging unit 8B in a concealed state. The additional, greater operational effects demonstrated are that, e.g., the durability of the urging unit for urging the first linking unit 3 and the second linking unit 4 in the outward-sliding direction can be dramatically improved, and the components provided with the device for urging relative movement can reliably be made more compact, as can the device for urging relative movement itself, which shall be apparent.

Specifically, in contrast to the configurations of the inventions according to the first and fifth aspects, the first linking unit 3 and the second linking unit 4 are not directly linked. The first linking unit 3 and the second linking unit 4 are linked via the linking unit 5 so as to be able to slide together in the outward direction in response to urging.

In other words, when a comparison is made between, e.g., a device S for urging relative movement according to the tenth and eleventh aspects and a device T for urging relative movement according to a comparative structure (a structure in which the first linking unit 3 and the second linking unit 4 are directly slidably linked), the amount of displacement of the respective urging units when the first linking unit 3 and the second linking unit 4 of the device S for urging relative movement, and the first linking unit 3 and the second linking unit 4 of the device T for urging relative movement slide the same distance in the inward-sliding direction is smaller for the device S for urging relative movement than for the device T for urging relative movement.

The reason for this effect is that, in the configuration of the device S for urging relative movement, the linking unit 5 is interposed between the first linking unit 3 and the second linking unit 4, and the urging units are provided between the linking unit 5 and the first linking unit 3 and the second linking unit 4. In other words, when the first linking unit 3 and the second linking unit 4 are made to move in the inward-sliding direction, and the respective urging units are displaced, the urging force of one urging unit and the urging force of the other urging unit are mutually absorbed (buffered) by the linking unit 5. The first linking unit 3 and the second linking unit 4 can therefore be slid in the inward direction using the same stroke as in the aforedescribed device T for urging relative movement but with a smaller amount of displacement of the urging units.

Therefore, since the amount of displacement of the urging units is small, the load on the urging units is reduced, and the durability of the urging units is dramatically improved. Moreover, the fact that the structure allows the stroke between the first linking unit 3 and the second linking unit 4 to be increased to a corresponding degree means the structure can be disposed on narrow components. For this and other reasons, the components provided with the device for urging relative movement can reliably be made more compact, as can the device for urging relative movement itself, which shall be apparent.

### EXAMPLES

A specific example of the present invention will be described with reference to the drawings.

In the present example, the present invention is applied to an overlaid, compact cellular telephone in the following configuration. The telephone is provided with an operating part that performs a keyboard function. Number keys, functions keys, and the like are arranged on the upper surface side of the long, thick plate-shaped first member 1 (main body part 1) comprising a circuit board, electricity source, and other electronic components housed within a case. The second member 2 (overlay part 2) overlays the first member 1, covers the operating part, and has a substantially identical long, thick plate shape. The first member 1 is linked to the second member 2 by a sliding structural part (relative-movement structural part) so as to allow substantially level sliding in a longitudinal direction.

A long liquid-crystal panel or other display part is provided to the upper surface side of the overlay part 2. Predetermined displays are produced when an incoming call is received, the screen or operating part is operated, or other events set in advance occur. Landscape images received or otherwise obtained from a television transmission, a DVD, or another source can be displayed while the overlay part is overlaid and closed.

The linkage between the main body part 1 and the overlay part 2 is made using the sliding structural part and is configured so as to allow the overlay part 2 to slide open and closed relative to the main body part 1. The configuration allows sliding between an overlaid and closed position, in which the operating part of the main body part 1 is concealed by the overlay part 2, and an open position, in which the overlay part 2 is slid out of place in the longitudinal direction, and the operating part is exposed.

The sliding structural part of the present example will be described first.

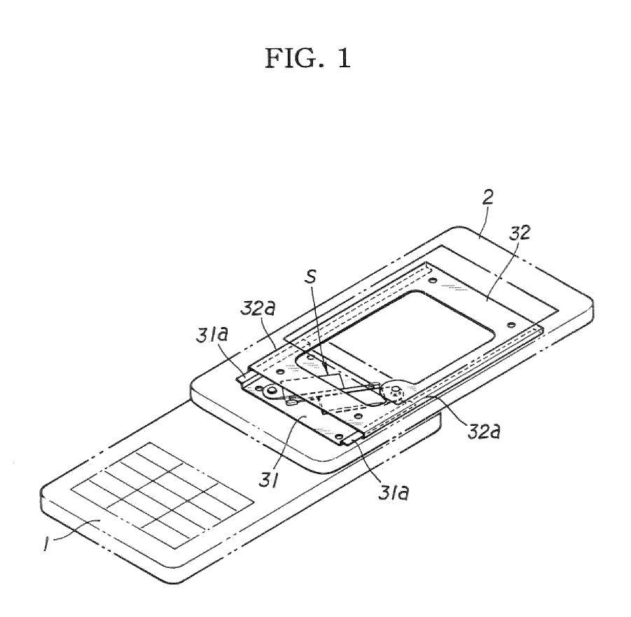

The sliding structural part links the first member 1 (main body part 1) and the second member 2 (overlay part 2), which is disposed overlaying the first member 1 (main body part 1), so as to allow sliding in a lengthwise direction. As shown in FIG. 1, a guide strip 31a is formed folded on the left and right edge parts of a plate-shaped guide member 31, which is part of the main body part 1. A plate-shaped sliding member 32 has a sliding strip 32a on the left and right edge parts. The sliding strip slidably engages with the guide strip 31a, which acts as a guide. The sliding member 32 is provided as part of the overlay part 2.

In the present example, therefore, the sliding member 32 slides relative to the guide member 31, whereby the second member 2 is configured so as to be able to slide relative to the main body part 1. The sliding structural part of the main body part 1 and the overlay part 2 is also provided with the device S for urging relative movement.

The device S for urging relative movement has the first linking unit 3 for linking to the main body part 1, and the second linking unit 4 that is connected to the first linking unit 3 so as to be able to slide in the outward-sliding direction in response to urging and that is linked to the overlay part 2. One end part of the urging unit 8 is connected to the urging unit connecting part 10 that is provided to the first linking unit 3. The other end part of the urging unit is connected to the urging unit connecting part 6 that is provided to the second linking unit 4. The part 12 for concealing and supporting the urging unit is provided to one or both of the first linking unit 3 and the second linking unit 4. The part for concealing and supporting the urging unit is positioned outwardly with respect to the urging unit 8 and is capable of supporting the urging unit 8 in a concealed state. The slidably linking sliding part 14 is provided to the part 12 for concealing and supporting the urging unit, one or both of the urging unit connecting part 6 of the second linking unit 4 and the urging unit connecting part 10 of the first linking unit 3 acting as guides. The first linking unit 3 and the second linking unit 4 are slidably linked.

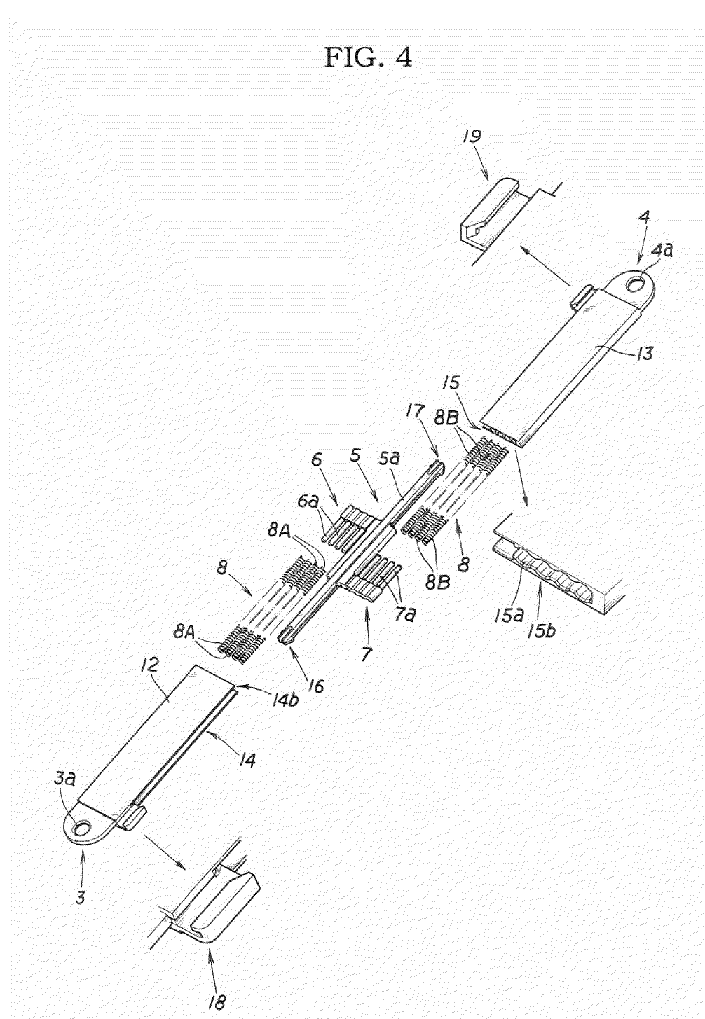

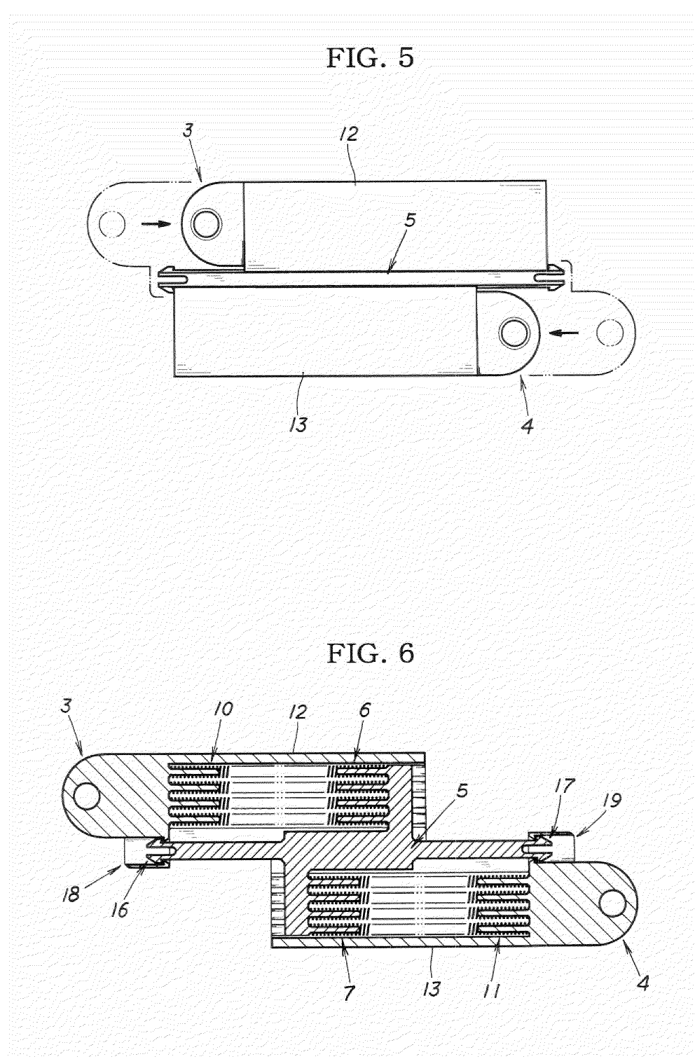

The main body of the device according to the aforedescribed device S for urging relative movement has the structure of the linking unit 5, which is described hereinafter, considered to be part of or integrated with the second linking unit 4 (a two-part structure comprising the first linking unit 3 and the second linking unit 4); however, in the main body of the device shown in FIGS. 4 through 6, the linking unit 5 is regarded as a unit that is completely separate from the second linking unit 4 (a three-part structure comprising the first linking unit 3, the second linking unit 4, and the linking unit 5). The two-part and the three-part structures both exhibit excellent operational effects. The three-part type exhibits more operational effects than the two-part type.

The device S for urging relative movement will be described below on the basis of an example configured in three parts: the first linking unit 3, the second linking unit 4, and the linking unit 5.

In other words, the device S for urging relative movement has the first linking unit 3 for linking to the main body part 1, the second linking unit 4 for linking to the overlay part 2 so as to be movable in the outward-sliding direction with respect to the first linking unit 3, and the linking unit 5 for linking the first linking unit 3 and the second linking unit 4 so as to allow sliding together in the outward direction (opposite directions) in response to urging.

More specifically, the main body of the device can be collapsed and expanded, and is composed of the first linking unit 3 for rotatably linking to the main body part 1 (the guide member 31); the second linking unit 4 for rotatably linking to the overlay part 2 (the sliding member 32); and the linking unit 5 for linking to the first linking unit 3 and the second linking unit 4 so as to allow both to slide in the outward direction. The first urging units 8A (compression springs composed of long coil springs) are provided between the first linking unit 3 and the linking unit 5 for urging sliding of the first linking unit 3 and the linking unit 5 together in the outward direction. The second urging units 8B (compression springs composed of long coil springs) are provided between the second linking unit 4 and the linking unit 5 for urging sliding of the second linking unit 4 and the linking unit 5 together in the outward direction. An urging structure for urging the first linking unit 3 and the second linking unit 4 in the outward-sliding direction is provided to the main body of the device.

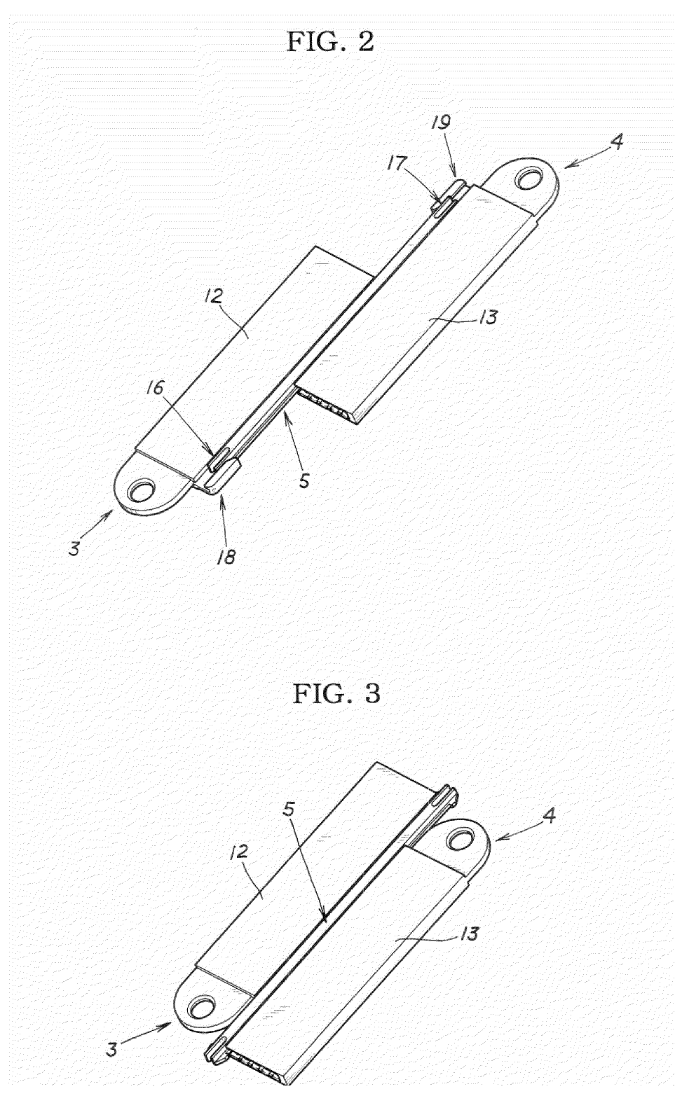

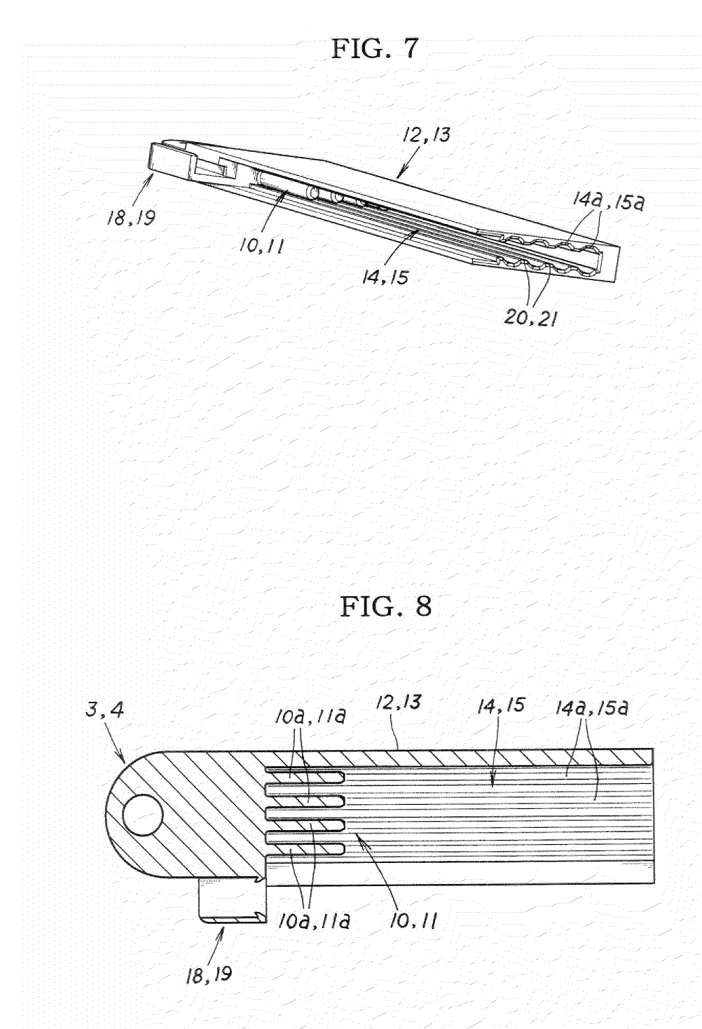

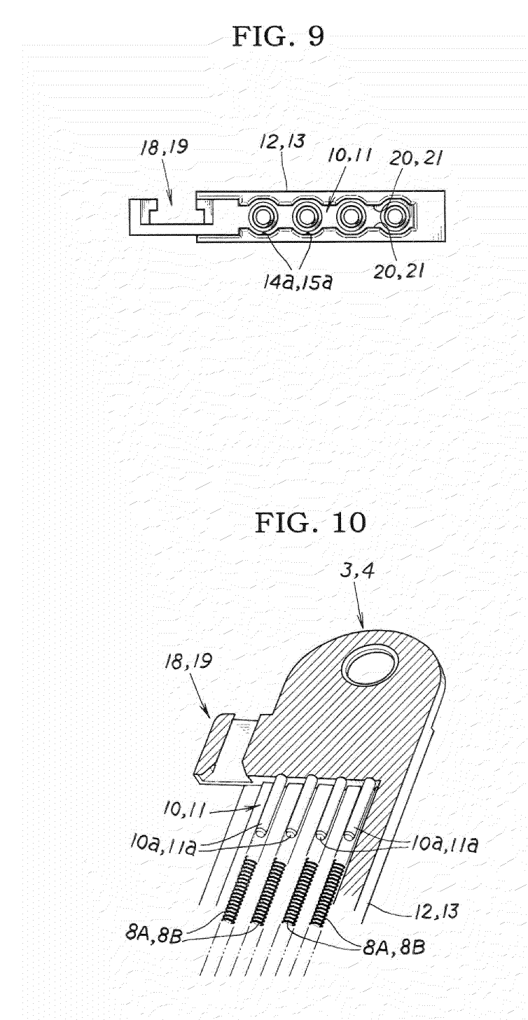

The first linking unit 3 and the second linking unit 4 have the same structure and are integrally formed as members made of an appropriate synthetic resin, as shown in FIGS. 1 through 10. Pivoted linking parts 3a, 4a are provided to one end for forming a pivoted link to the main body part 1 (the guide member 31) and the overlay part 2 (the sliding member 32), respectively. The linking units are flat, plate-shaped case structures that have a cross-section shaped as an open-sided square. The linking units have upper and lower thin plate units formed integrally with sliding parts 14, 15 that have a hollow structure and contain internal sliding holes along the lengthwise direction.

As shown in FIGS. 6 through 10, one end part of the first urging units 8A is connected to the urging unit connecting part 6 provided to the linking unit 5 (described hereinafter). The other end part is connected to the urging unit connecting part 10 that is provided to the first linking unit 3. One end part of the second urging units 8B is connected to an urging unit connecting part 7 provided to the linking unit 5. The other end part is connected to the urging unit connecting part 11 that is provided to the second linking unit 4.

The urging unit connecting parts 10, 11 of the first linking unit 3 and the second linking unit 4 have a plurality (four) of convex parts 10a, 11a that are arranged in parallel and can fit to the coil-shaped first urging units 8A and second urging units 8B.

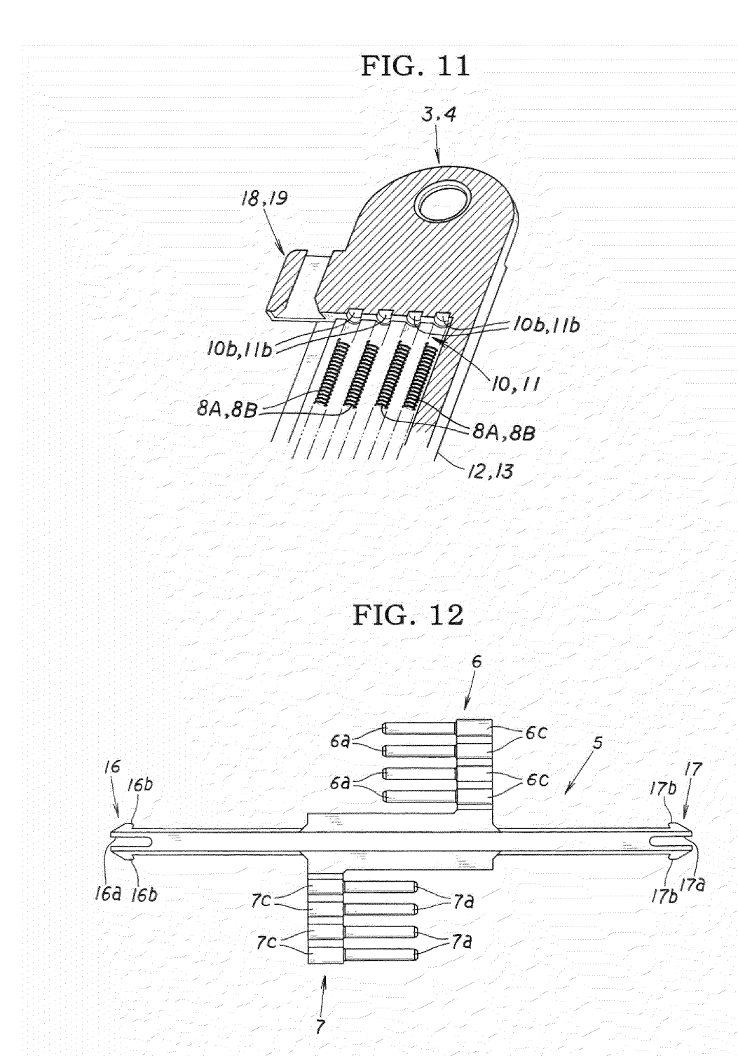

The urging unit connecting parts 10, 11 of the first linking unit 3 and the second linking unit 4 may also have a plurality (four) of concave parts 10b, 11b arranged in parallel, as shown in FIG. 11.

As shown in FIGS. 1 through 10, parts for concealing and supporting the urging units (the first part 12 for concealing and supporting the urging unit and the second part 13 for concealing and supporting the urging unit) that can support the respective urging units 8 (the first urging units 8A and the second urging units 8B) in a concealed state are provided to one or both of the first linking unit 3 and the second linking unit 4. The parts for concealing and supporting the urging units have a thin plate shape and are positioned both above and below (or either above or below) the urging units 8 outwardly with respect thereto.

Specifically, the first part 12 for concealing and supporting the urging unit, which has a flat, thin case shape and a cross-section having an open-square shape, is provided to the first linking unit 3 (to one or both of the first linking unit 3 and the linking unit 5). The first part for concealing and supporting the urging unit is positioned outwardly with respect to the first urging units 8A and is capable of supporting the first urging units 8A in a concealed state. The second part 13 for concealing and supporting the urging unit, which has a flat, thin case shape and a cross-section having an open-square shape, is provided to the second linking unit 4 (to one or both of the second linking unit 4 and the linking unit 5). The second part for concealing and supporting the urging unit is positioned outwardly with respect to the second urging units 8B and is capable of supporting the second urging units 8B in a concealed state.

The slidably linking sliding part 14 is provided to the inner surface of the first part 12 for concealing and supporting the urging unit, the urging unit connecting part 6 of the linking unit 5 (one or both of the urging unit connecting part 6 of the linking unit 5 and the urging unit connecting part 10 of the first linking unit 3) acting as a guide. The slidably linking sliding part 15 is provided to the inner surface of the second part 13 for concealing and supporting the urging unit, the urging unit connecting part 7 of the linking unit 5 (one or both of the urging unit connecting part 7 of the linking unit 5 and the urging unit connecting part 11 of the second linking unit 4) acting as a guide.

The sliding parts 14, 15 have curved grooves 14a, 15a, respectively, arranged in parallel on the opposing inner wall surfaces. This configuration allows the respective urging unit connecting part 6 and urging unit connecting part 7 of the linking unit 5 (described hereinafter) to slide in a fitted state.

The sliding parts 14, 15 have a function of sliding along the respective peripheral surfaces of the urging unit connecting part 6 and the urging unit connecting part 7 of the linking unit 5, and are configured as support surfaces for supporting the respective outer, surfaces of the first urging units 8A and the second urging units 8B.

The support surfaces of the first part 12 for concealing and supporting the urging unit (the sliding part 14) and the second part 13 for concealing and supporting the urging unit (the sliding part 15) are configured so as to prevent the long first urging units 8A and second urging units 8B from flexing and deforming toward the outside during the urging action (during the compressive urging action) of the first urging units 8A and the second urging units 8B for urging the first linking unit 3 and the second linking unit 4 in the outward-sliding direction.

A contact-preventing unit 20 for preventing contact between the first urging units 8A is positioned between the first urging units 8A and is provided to the support surface associated with the sliding part 14 of the first part 12 for concealing and supporting the urging unit. A contact-preventing unit 21 for preventing contact between the second urging units 8B is positioned between the second urging units BB and is provided to the support surface associated with the sliding part 15 of the second part 13 for concealing and supporting the urging unit.

The contact-preventing units 20, 21 comprise the components between the respective curved grooves 14a, 15a of the sliding parts 14, 15, and can prevent contact between the adjoining urging units 8A, 8B.

The configuration is such that at least the sliding component between the sliding part 14, which is provided to the first part 12 for concealing and supporting the urging unit, and the urging unit connecting part 6 of the linking unit 5 (one or both of the urging unit connecting part 10 of the first linking unit 3 and the urging unit connecting part 6), is a member made of synthetic resin, the sliding part 14 sliding along the urging unit connecting parts. The configuration is also such that at least the sliding component between the sliding part 15, which is provided to the second part 13 for concealing and supporting the urging unit, and the urging unit connecting part 7 of the linking unit 5 (one or both of the urging unit connecting part 11 of the second linking unit 4 and the urging unit connecting part 7), is a member made of synthetic resin, the sliding part 15 sliding along the urging unit connecting parts.

In the present example, the first part 12 for concealing and supporting the urging unit and associated with the first linking unit 3 (one or both of the first linking unit 3 and the linking unit 5) is provided with the retaining lock part 18 for interlocking with the lock part 16, which is provided to the linking unit 5 (one or both of the linking unit 5 and the first linking unit 3), at a predetermined location where the sliding part 14 has slid against the return urging of the first urging units 8A. The second part 13 for concealing and supporting the urging unit and associated with the second linking unit 4 (one or both of the second linking unit 4 and the linking unit 5) is provided with a retaining lock part 19 for interlocking with a lock part 17, which is provided to the linking unit 5 (one or both of the linking unit 5 and the second linking unit 4), at a predetermined location where the sliding part 15 has slid against the return urging of the second urging units 8B.

The retaining lock parts 18, 19 are provided with fitting parts that can be fit to a base unit 5a associated with the linking unit 5 (described hereinafter). When the lock parts 16, 17 (described hereinafter) are pressed into and thereby fitted within the retaining lock parts 18, 19, convex parts 16b, 17b of the lock parts 16, 17 interlock with and hold to the retaining lock parts 18, 19.

The linking unit 5 has the urging unit connecting part 6, which faces the urging unit connecting part 10 of the first linking unit 3 and spans across the first urging units 8A toward the urging unit connecting part 10; and the urging unit connecting part 7, which faces the urging unit connecting part 11 of the second linking unit 4 and spans across the second urging units 8B toward the urging unit connecting part 11.

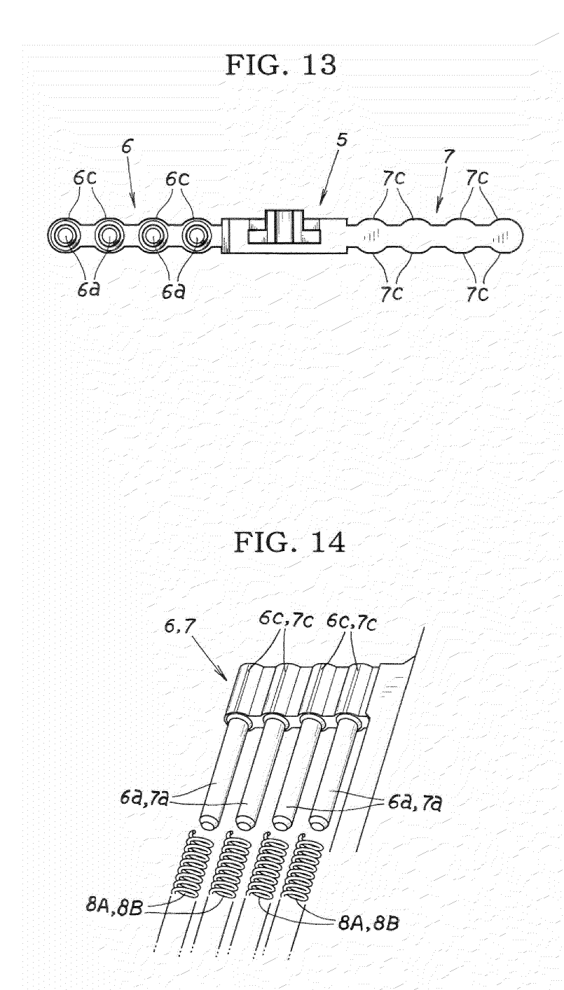

Specifically, the linking unit 5 is formed as a member made of an appropriate synthetic resin, as shown in FIGS. 4, 6, 12, and 13. Protruding parts that project to respective left and right central positions on the rod-shaped base unit 5a are configured as the urging unit connecting parts 6, 7.

The urging unit connecting parts 6, 7 have a configuration provided with a plurality (four) of convex parts 6a, 7a, which can fit to the first urging units 8A and the second urging units 8B, on the end part at the location where the aforedescribed urging unit connecting parts 10, 11 of the first linking unit 3 and the second linking unit 4 face one another.

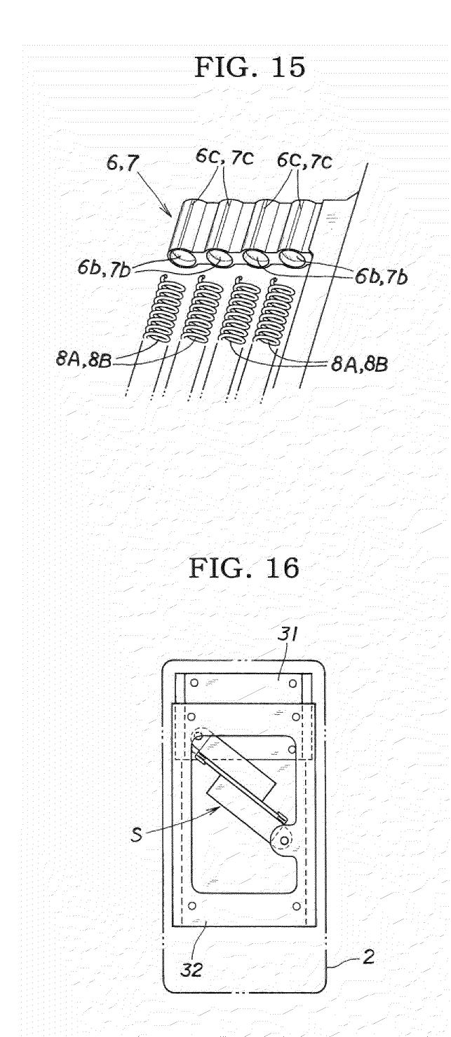

The urging unit connecting parts 6, 7 of the linking unit 5 may also be configured having a plurality (four) of concave parts 6b, 7b arranged in parallel, as shown in FIG. 15.

The urging unit connecting parts 6, 7 are configured so as to slidably fit to the sliding parts 14, 15 of the aforedescribed first part 12 for concealing and supporting the urging unit and the second part 13 for concealing and supporting the urging unit.

Specifically, a plurality (four) of convex ridges 6c, 7c are arranged in parallel on the peripheral surface (upper and lower surface) of the urging unit connecting parts 6, 7. The convex strips are shaped so as to match with the aforedescribed grooves 14a, 15a formed in the sliding parts 14, 15, and are configured to enable the urging unit connecting parts 6, 7 to fit in respective distal openings 14b, 15b in the sliding parts 14, 15 so as to be capable of sliding out therefrom.

The lock parts 16, 17, which interlock with the retaining lock parts 18, 19 provided to the first part 12 for concealing and supporting the urging unit and the second part 13 for concealing and supporting the urging unit, are provided to both front and rear end components of the base unit 5a associated with the linking unit 5.

The lock parts 16, 17 are provided with two-step parts that elastically deform towards the inside via slits 16a, 17a. The lock parts are also provided with hook-shaped convex parts 16b, 17b on left and right parts of components provided to the slits 16a, 17a. The configuration is such that when the sliding parts 14, 15 are fit to the urging unit connecting parts 6, 7 against the return urging of the first urging units 8A and the second urging units 8B, the left and right lock parts 16, 17 flexibly deform inwardly at locations provided to the retaining lock parts 18, 19. The lock parts then interlock with the retaining lock parts 18, 19 by coming back to the outside.

When the sliding parts 14, 15 are fit to the urging unit connecting parts 6, 7, the first urging units 8A and the second urging units 8B (compression springs) are fit to the urging unit connecting parts 6, 7 (the convex parts 6a, 7a). One end of the first urging units 8A and the second urging units 8B is connected to the urging unit connecting parts 6, 7 of the linking unit 5, and the other end connects to the urging unit connecting parts 10, 11 of the first linking unit 3 and the second linking unit 4.

Therefore, the first linking unit 3 and the second linking unit 4 are linked to the linking unit 5 (the urging unit connecting parts 6, 7) so as to be able to slide together in the outward direction as a result of the first part 12 for concealing and supporting the urging unit and the second part 13 for concealing and supporting the urging unit (sliding parts 14, 15) being fitted in a state in which the first urging units 8A and the second urging units 8B are fitted to the urging unit connecting parts 6, 7 of the linking unit 5, and the retaining lock parts 18, 19 interlocking with the lock parts 16, 17. The first linking unit 3 and the second linking unit 4 are both constantly urged in the outward-sliding direction (distal direction) in this state by the urging of the first urging units 8A and the second urging units 8B. The first linking unit 3 and the second linking unit 4 can be moved in the inward-sliding direction against the urging in the outward-sliding direction. The urging force that is produced when the first linking unit 3 and the second linking unit 4 are moved in the inward-sliding direction urges both the first linking unit 3 and the second linking unit 4 in the outward-sliding direction. This force is a relative-movement urging force for urging relative movement of the overlay part 2 relative to the main body part 1 when the device S for urging relative movement is provided to the aforedescribed sliding structural part.

According to the above, when the main body of the device composed of the first linking unit 3, the second linking unit 4, and the linking unit 5 is contracted by the procedure for moving the pivoted linking part 3a of the first linking unit 3 and the pivoted linking part 4a of the second linking unit 4 in the inward-sliding direction, compression urging is produced by the first urging units 8A and the second urging units 8B. This compression urging is an urging force for urging both the first linking unit 3 and the second linking unit 4 in the outward-sliding direction.

When the thus-configured device S for urging relative movement is provided to the sliding structural part of the main body part 1 and the overlay part 2, the pivoted linking part 3a of the first linking unit 3 is pivotably linked to the main body part 1 (the guide member 31), and the pivoted linking part 4a of the second linking unit 4 is pivotably linked to the overlay part 2 (the sliding member 32).

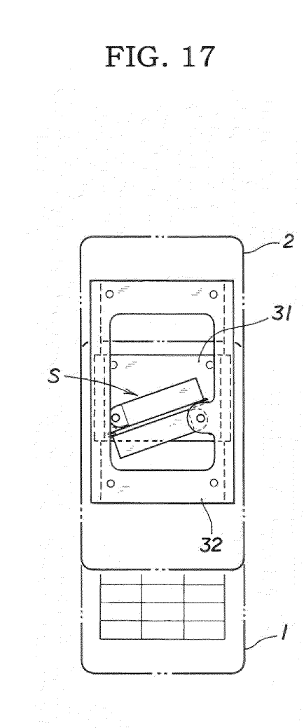

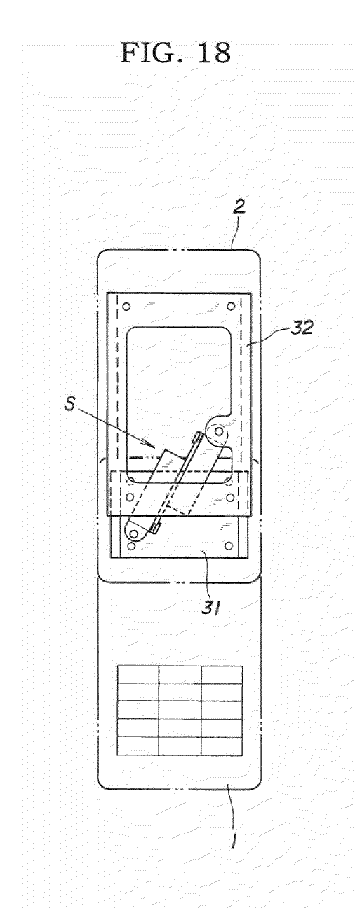

Return urging for automatically sliding the overlay part 2 back to the overlaid and closed position is produced in this state until the overlay part 2 has slid a predetermined distance relative to the main body part 1. Once the predetermined distance has been covered, propelling urging for sliding automatically forward in the opposite direction to the open position is produced (see FIGS. 16, 17, and 18).

The configuration of the present example described above allows the first linking unit 3 and the second linking unit 4 employed in the conventional art examples to slide, and obviates the use of a shaft for supporting the urging units (coil springs). Therefore, the noise conventionally generated when the urging unit rubs against the shaft during operation is not produced, the durability of the first urging units 8A and the second urging units 8B can be improved, and smooth sliding in the sliding structure is achieved. As mentioned above, the shaft is unnecessary, and the first urging units 8A and the second urging units BB can be assembled via the assembly of the main body of the device (e.g., the first linking unit 3 and the second linking unit 4), resulting in extremely simple assembly and lower costs.

In the present example, the parts 12, 13 for concealing and supporting the urging units make it possible to prevent foreign matter from adhering to the first urging units 8A and the second urging units 8B or the first urging units 8A and the second urging units 8B from contacting external structural elements (e.g., plate metal constituting sliding devices and flexible wires). The structure is also waterproof, which additionally improves the durability of the first urging units 8A and the second urging units 8B. The grease conventionally applied to the periphery of the first urging units 8A and the second urging units BB is obviated or largely unnecessary; therefore, assembly can be performed very readily, and costs are reduced.

In the present example, the urging unit connecting parts 6, 7 of the linking unit 5 function as guides for the sliding parts 14, 15; therefore, the dual functionality of the parts allows only the minimally required parts to be used, weight to be reduced, and a degree of compactness to be reliably attained.

Smooth sliding is achieved due to a configuration in which the sliding component between the sliding parts 14, 15, which are provided to the parts 12, 13 for concealing and supporting the urging units, and the urging unit connecting parts 6, 7 of the linking unit 5, is a member made of synthetic resin, the sliding parts 14, 15 sliding along the urging unit connecting parts. Moreover, no noise is produced during operation (while sliding).

The first part 12 for concealing and supporting the urging unit and the second part 13 for concealing and supporting the urging unit are shaped as flat, thin cases in the present example, and therefore the device for urging relative movement and the, e.g., electronic apparatus provided with the device for urging relative movement, will be further reduced in weight and made more compact.

Contact between the first urging units 8A and the second urging units 8B is reliably prevented, because a plurality of the first urging units 8A are arranged in parallel on the urging unit connecting part 6 of the linking unit 5 and the urging unit connecting part 10 of the first linking unit 3, and the contact-preventing unit 20 for preventing contact between the first urging units 8A is positioned between the first urging units 8A and is provided to the first part 12 for concealing and supporting the urging unit. A plurality of the second urging units 8B are arranged in parallel on the urging unit connecting part 7 of the linking unit 5 and the urging unit connecting part 11 of the second linking unit 4, and the contact-preventing unit 21 for preventing contact between the second urging units 8B is positioned between the second urging units 8B and is provided to the second part 13 for concealing and supporting the urging unit. Durability of the first urging units 8A and the second urging units 8B can also be dramatically improved in this respect.

In the present example, the first linking unit 3 is provided with the retaining lock part 18 for interlocking with the lock part 16, which is provided to the linking unit 5, at a predetermined location where the sliding part 14 has slid against the return urging of the first urging units 8A, and the second linking unit 4 is provided with the retaining lock part 19 for interlocking with the lock part 17, which is provided to linking unit 5, at a predetermined location where the sliding part 15 has slid against the return urging of the second urging units 8B. The assembly of the main body of the device will therefore be completed merely by the retaining lock parts 18, 19 interlocking with the lock parts 16, 17. Therefore, assembly can be very readily performed, mass productivity will be dramatically improved, and costs will be reduced.

The present example has a configuration in which the first linking unit 3 for linking to the first member 1, the second linking unit 4 for linking to the second member 2, and the linking unit 5 for linking the first linking unit 3 and the second linking unit 4 so as to allow sliding together in the outward direction in response to urging are present. One end part of the first urging units 8A is connected to the urging unit connecting part 6 provided to the linking unit 5. The other end part is connected to the urging unit connecting part 10 that is provided to the first linking unit 3. One end part of the second urging units 8B is connected to an urging unit connecting part 7 provided to the linking unit 5. The other end part is connected to an urging unit connecting part 11 that is provided to the second linking unit 4. The first part 12 for concealing and supporting the urging unit is provided to first linking unit 3. The first part for concealing and supporting the urging unit is positioned outwardly with respect to the first urging units 8A and is capable of supporting the first urging units 8A in a concealed state. The second part 13 for concealing and supporting the urging unit is provided to the second linking unit 4. The second part for concealing and supporting the urging unit is positioned outwardly with respect to the second urging units 8B and is capable of supporting the second urging units 8B in a concealed state. The slidably linking sliding part 14 is provided to the first part 12 for concealing and supporting the urging unit, the urging unit connecting part 6 of the linking unit 5 acting as a guide. The slidably linking sliding part 15 is provided to the second part 13 for concealing and supporting the urging unit, the urging unit connecting part 7 of the linking unit 5 acting as a guide. The first linking unit 3 and the second linking unit 4 are slidably linked to the linking unit 5. The pitch between the first linking unit 3 and the second linking unit 4 can therefore be narrowed, and the device S for urging relative movement itself can be made more compact in a simple and reliable manner. Therefore, the, e.g., electronic apparatus provided with the device S for urging relative movement can also be made more compact, and the durability of both the first linking unit 3 and the second linking unit 4 can be dramatically improved.

In the present example, the sliding structural part: for causing the overlay part 2 to slide relative to the main body part 1 along the overlay surface is employed as the linking component (relative-movement structural part) of the first member 1 and the second member 2 provided with the aforedescribed device S for urging relative movement; however, e.g., a rotational structural part for allowing the overlay part 2 to rotate relative to the main body part 1 substantially parallel to the overlay surface may also be employed.

Specifically, the rotational structural part employed in the present example is built into one of the upper part and the lower part of the aforedescribed sliding structural part. The rotational structural part may also be provided with the device for urging relative movement. The device S for urging relative movement according to the present example may also be provided to the relative-movement structural part of the main body part 1 and the second member 2 having a simple rotational structural part that is not provided with the sliding structural part.

The present example is not provided by way of limitation to the present invention. The specific configuration of the respective constituting elements can be designed as appropriate.

1. A device for urging relative movement of a first member and a second member that are linked so as to allow relative movement, the device for urging relative movement comprising:
a first linking unit for linking to the first member; and
a second linking unit for linking to the second member, the second linking unit being connected to the first linking unit so as to be able to slide in an outward-sliding direction in response to urging, wherein
one end part of an urging unit is connected to an urging unit connecting part that is provided to the first linking unit, and the other end part of the urging unit is connected to an urging unit connecting part that is provided to the second linking unit;
a part for concealing and supporting the urging unit is provided to one or both of the first linking unit and the second linking unit, the part for concealing and supporting the urging unit being positioned outwardly with respect to the urging unit and being capable of supporting the urging unit in a concealed state; and
the part for concealing and supporting the urging unit is configured so as to prevent the urging unit from outwardly deforming while the urging unit urges the first linking unit and the second linking unit in the outward-sliding direction.

2. The device for urging relative movement according to claim 1, wherein
first end parts of a plurality of respective urging units arranged in parallel are connected to the urging unit connecting part that is provided to the first linking unit, and second end parts of the urging units are connected to the urging unit connecting part that is provided to the second linking unit; and
the part for concealing and supporting the urging unit is provided to one or both of the first linking unit and the second linking unit, the part for concealing and supporting the urging unit being positioned outwardly with respect to the urging units and being capable of supporting the urging units in a concealed state.

3. The device for urging relative movement according to claim 2, further comprising a contact-preventing unit for preventing contact between the urging units, the contact-preventing unit being positioned between the urging units and being provided to the part for concealing and supporting the urging unit.

4. The device for urging relative movement according to claim 1, further comprising:
a thin plate unit positioned outwardly with respect to the urging unit on an upper side or a lower side of the urging unit, or both upper and lower sides thereof, wherein
the part for concealing and supporting the urging unit that is capable of supporting the urging unit in a concealed state is provided to one or both of the first linking unit and the second linking unit.

5. A device for urging relative movement of a first member and a second member that are linked so as to allow relative movement, the device for urging relative movement comprising:
a first linking unit for linking to the first member; and
a second linking unit for linking to the second member, the second linking unit being connected to the first linking unit so as to be able to slide in an outward-sliding direction in response to urging, wherein
one end part of an urging unit is connected to an urging unit connecting part that is provided to the first linking unit, and the other end part of the urging unit is connected to an urging unit connecting part that is provided to the second linking unit;
a part for concealing and supporting the urging unit is provided to one or both of the first linking unit and the second linking unit, the part for concealing and supporting the urging unit being positioned outwardly with respect to the urging unit and being capable of supporting the urging unit in a concealed state;
a slidably linking sliding part is provided to the part for concealing and supporting the urging unit, one or both of the urging unit connecting part of the second linking unit and the urging unit connecting part of the first linking unit acting as guides; and
the first linking unit and second linking unit are slidably linked.

6. The device for urging relative movement according to claim 5, wherein a sliding component between the sliding part, which is provided to the part for concealing and supporting the urging unit, and one or both of the urging unit connecting part of the second linking unit and the urging unit connecting part of the first linking unit, is a member made of a synthetic resin, the sliding part sliding along the urging unit connecting parts.

7. The device for urging relative movement according to claim 5, wherein
a plurality of the urging units are arranged in parallel on the urging unit connecting parts; and
a contact-preventing unit for preventing contact between the urging units is positioned between the urging units and is provided to the part for concealing and supporting the urging unit.

8. The device for urging relative movement according to claim 5, further comprising a thin plate unit positioned outwardly with respect to the urging unit on an upper side or a lower side of the urging unit, or both upper and lower sides thereof, the thin plate unit being provided to the part for concealing and supporting the urging unit.

9. The device for urging relative movement according to claim 5, further comprising a retaining lock part for interlocking with a lock part, which is provided to one or both of the second linking unit and the first linking unit, at a predetermined location where the sliding part has slid against a return urging of the urging unit, the retaining lock part being provided to one or both of the first linking unit and the second linking unit.

10. A device for urging relative movement of a first member and a second member that are linked so as to allow relative movement, the device for urging relative movement comprising:
a first linking unit for linking to the first member;
a second linking unit for linking to the second member; and
a linking unit for linking to the first linking unit and the second linking unit so as to allow sliding together in an outward direction in response to urging, wherein
one end part of a first urging unit is connected to an urging unit connecting part that is provided to the linking unit, and the other end part of the first urging unit is connected to an urging unit connecting part that is provided to the first linking unit;
one end part of a second urging unit is connected to an urging unit connecting part that is provided to the linking unit, and the other end part of the second urging unit is connected to an urging unit connecting part that is provided to the second linking unit;
a first part for concealing and supporting the urging unit is provided to one or both of the first linking unit and the linking unit, the first part for concealing and supporting the urging unit being positioned outwardly with respect to the first urging unit and being capable of supporting the first urging unit in a concealed state;
a second part for concealing and supporting the urging unit is provided to one or both of the second linking unit and the linking unit, the second part for concealing and supporting the urging unit being positioned outwardly with respect to the second urging unit and being capable of supporting the second urging unit in a concealed state;
the first part for concealing and supporting the urging unit is configured so as to prevent the first urging unit from outwardly deforming while the first urging unit urges the first linking unit and the linking unit in the outward direction; and
the second part for concealing and supporting the urging unit is configured so as to prevent the second urging unit from outwardly deforming while the second urging unit urges the second linking unit and the linking unit in the outward direction.

11. A device for urging relative movement of a first member and a second member that are linked so as to allow relative movement, the device for urging relative movement comprising:
a first linking unit for linking to the first member;
a second linking unit for linking to the second member; and
a linking unit for linking to the first linking unit and the second linking unit so as to allow sliding together in an outward direction in response to urging, wherein
one end part of a first urging unit is connected to an urging unit connecting part that is provided to the linking unit, and the other end part of the first urging unit is connected to an urging unit connecting part that is provided to the first linking unit;
one end part of a second urging unit is connected to an urging unit connecting part that is provided to the linking unit, and the other end part of the second urging unit is connected to an urging unit connecting part that is provided to the second linking unit;
a first part for concealing and supporting the urging unit is provided to one or both of the first linking unit and the linking unit, the first part for concealing and supporting the urging unit being positioned outwardly with respect to the first urging unit and being capable of supporting the first urging unit in a concealed state;
a second part for concealing and supporting the urging unit is provided to one or both of the second linking unit and the linking unit, the second part for concealing and supporting the urging unit being positioned outwardly with respect to the second urging unit and being capable of supporting the second urging unit in a concealed state;
a slidably linking sliding part is provided to the first part for concealing and supporting the urging unit, one or both of the urging unit connecting part of the linking unit and the urging unit connecting part of the first linking unit acting as guides;
a slidably linking sliding part is provided to the second part for concealing and supporting the urging unit, one or both of the urging unit connecting part of the linking unit and the urging unit connecting part of the second linking unit acting as guides; and
the first linking unit and the second linking unit are slidably linked to the linking unit.

12. An electronic apparatus, comprising the device for urging relative movement according to claim 1, the device for urging relative movement being provided to a relative-movement structural part for linking the first member, upon which an operating part or the like is disposed, and the second member, upon which a display part or the like is disposed, so as to allow relative movement.

13. The device for urging relative movement according to claim 6, wherein
a plurality of the urging units are arranged in parallel on the urging unit connecting parts; and
a contact-preventing unit for preventing contact between the urging units is positioned between the urging units and is provided to the part for concealing and supporting the urging unit.

14. An electronic apparatus, comprising the device for urging relative movement according to claim 2, the device for urging relative movement being provided to a relative-movement structural part for linking the first member, upon which an operating part or the like is disposed, and the second member, upon which a display part or the like is disposed, so as to allow relative movement.

15. An electronic apparatus, comprising the device for urging relative movement according to claim 3, the device for urging relative movement being provided to a relative-movement structural part for linking the first member, upon which an operating part or the like is disposed, and the second member, upon which a display part or the like is disposed, so as to allow relative movement.

16. An electronic apparatus, comprising the device for urging relative movement according to claim 4, the device for urging relative movement being provided to a relative-movement structural part for linking the first member, upon which an operating part or the like is disposed, and the second member, upon which a display part or the like is disposed, so as to allow relative movement.

17. An electronic apparatus, comprising the device for urging relative movement according to claim 5, the device for urging relative movement being provided to a relative-movement structural part for linking the first member, upon which an operating part or the like is disposed, and the second member, upon which a display part or the like is disposed, so as to allow relative movement.

18. An electronic apparatus, comprising the device for urging relative movement according to claim 6, the device for urging relative movement being provided to a relative-movement structural part for linking the first member, upon which an operating part or the like is disposed, and the second member, upon which a display part or the like is disposed, so as to allow relative movement.

19. An electronic apparatus, comprising the device for urging relative movement according to claim 7, the device for urging relative movement being provided to a relative-movement structural part for linking the first member, upon which an operating part or the like is disposed, and the second member, upon which a display part or the like is disposed, so as to allow relative movement.

20. An electronic apparatus, comprising the device for urging relative movement according to claim 8, the device for urging relative movement being provided to a relative-movement structural part for linking the first member, upon which an operating part or the like is disposed, and the second member, upon which a display part or the like is disposed, so as to allow relative movement.
